(19) United States
(12) Patent Application Publication
(10) Pub. No.: US 2007/0184319 A1
(43) Pub. Date: Aug. 9, 2007

(54) Method and apparatus for controlling the differential pressure in a fuel cell

(75) Inventors: Uwe Limbeck, Kirchheim (DE); Cosimo S. Mazzotta, Ulm (DE); Uwe Pasera, Stuttgart (DE); Sven Schmalzriedt, Ostfildern (DE); Peter Wiesner, Ulm (DE)

Correspondence Address: CROWELL & MORING LLP;INTELLECTUAL PROPERTY GROUP, P.O. BOX 14300, WASHINGTON, DC, 20044-4300, US

(73) Assignee: NuCellSys GmbH, Kirchheim/Teck-Nabern (DE)

(21) Appl. No.: 11/702,059

(22) Filed: Feb. 5, 2007

(30) Foreign Application Priority Data
Feb. 6, 2006 (DE) 102006005175.0

(51) Int. Cl. H01M 8/04

(52) U.S. Cl. 429/25; 429/13

(57) ABSTRACT

A device for controlling the differential pressure between an anode area and a cathode area of a fuel cell has a differential pressure sensor for measuring the differential pressure between the anode area and the cathode area. A first actuator controls the flow of fuel into the anode area, and a control device regulates or controls the first actuator, on the basis of the signal of the differential pressure sensor.

### BACKGROUND AND SUMMARY OF THE INVENTION

This application claims the priority of German patent document 102006005175.0, filed Feb. 6, 2006, the disclosure of which is expressly incorporated by reference herein.

The present invention relates to a method and apparatus for controlling the differential pressure between the anode and cathode areas of a fuel cell. The device is connected or connectable with a refuellable storage tank for hydrogen, and has a first actuator for adjusting the pressure in the anode area and/or cathode area.

Fuel cells are electro-chemical energy converters which produce electric energy from a fuel, such as hydrogen, and an oxidant, such as oxygen, without thermal or mechanical intermediate processes. A particularly promising form of fuel cell for use in motor vehicles is the PEM fuel cell (polymer electrolyte membrane fuel cell), which has a positive electrode (cathode) and a negative electrode (anode), which are separated by an electrolyte. The electrolyte is formed of a plastic membrane which is insulating for electrons and has a good conductivity for the hydrogen ions. In addition, the plastic membrane forms a mechanical block between the fuel in the anode area and the oxidant in the cathode area.

Japanese Patent Document JP 03205765 A describes a method and apparatus for controlling the differential pressure between the electrodes of a fuel cell in a fuel cell system. The fuel cell system has a reformer device, and the gas outlets of the anode and the cathode of the fuel cell lead into the reformer device, and are mutually connected in this manner. The differential pressure between the anode and cathode areas is measured by a differential pressure sensor. Any differential pressures which may occur are used for controlling a bypass valve which short-circuits a gas pipe section between the anode outlet device and the reformer inlet.

U.S. Pat. No. 5,059,494 discloses a fuel cell energy supply system which also has a reformer, with the outlets of the anode area and the cathode area being connected in a gas-conducting or communicating manner via the reformer. Differential pressure between the anode area and the cathode area is measured by a differential pressure sensor, and the gas outlet device of the anode is adjusted on the basis of the measured signal by way of valves, so that the differential pressure corresponds to a defined desired value.

German Patent Document DE 10 2004 013487 A describes a fuel cell system which uses hydrogen from a storage tank as the fuel. A pressure control device controls a hydrogen pressure controller such that the ratio of the pressure of the hydrogen gas fed to the anode is optimized with respect to the pressure of the air fed to the cathode. The construction and method of operation of this control is not disclosed in the document.

One object of the present invention is to provide a method and apparatus which can control the differential pressure between the cathode and the anode of a fuel cell in a simple manner.

Another object of the invention is to provide a method and apparatus which are suitable and/or constructed for the control (particularly for the controlling and/or regulating) of the differential pressure between an anode area and a cathode area of a fuel cell that is of an arbitrary construction. Particularly preferably, however, it is a fuel cell in the PEM construction.

These and other objects and advantages are achieved by the method and apparatus according to the invention. The fuel cell has an anode area and a cathode area which are either formed by a particularly porous and/or grid-type anode or cathode, or are implemented as an anode chamber with an anode arranged therein or as a cathode chamber with a cathode arranged therein.

The device according to the invention is connectable with a refuellable hydrogen storage tank, which is constructed to receive hydrogen of a purity of more than 80%, preferably more than 90%, and particularly more than 95%. (Preferably, the percent information may relate to either percent by volume or percent by mass.) The gas outlet devices of the anode area and the cathode area are preferably mutually insulated, so that the residual gases from each of them are separately emitted to the environment, and are not mixed within the device or burned together with one another and/or remain unmixed.

The device according to the invention is preferably used in a mobile fuel cell system with a plurality of fuel cells, the fuel cell system having a reformer-free fuel supply system. In particular, the hydrogen is not generated by a local reformer that is transported together with the fuel cell. The fuel cell system preferably operates at maximum temperature that is less than 150° C., and in particular less than 100° C.

Furthermore, the apparatus according to the invention includes a first actuator for adjusting or controlling the pressure in the anode area and/or in the cathode area. In addition, a differential pressure sensor is provided for measuring the differential pressure (that is, the relative pressure difference) between the anode area and the cathode area. A control device is provided for controlling and/or regulating the first actuator based on signals from the differential pressure sensor. The control device may be constructed as an integral component of the first actuator or separately or as an integral component of a higher ranking control with additional functions. In particular, a regulating and/or adjusting circuit is formed, in which case the pressure in the cathode area and/or anode area forms the adjusting variable.

The invention is based on the proposition that the use of the differential pressure signal facilitates particularly simple and interference-resistant regulation and/or control of the differential pressure in the case of fuel cell systems which operate without a reformer and (therefore without a communicating connection between the outlet devices of the anode and of the cathode area). Such regulation and/or control is particularly useful for minimizing the mechanical stressing of the membrane between the anode and cathode area in the fuel cell.

In a preferred embodiment, the first actuator controls the flow of fuel into the anode area, and is arranged in the anode supply circuit and/or circulating system or branch, such that it acts directly upon the feeding of the fuel. This embodiment has the advantage that this form of adjusting variable permits highly dynamic tracking of the pressure in the anode area. As an alternative, the first actuator controls the flow of air into the into the cathode area or the draining of residual gases from the cathode or anode area.

In a preferred further embodiment of the device, the differential pressure sensor is arranged and/or constructed such that the pressure is measured at a first measuring point in the inlet or outlet device of the anode area, and a second measuring point in the inlet or outlet device of the cathode area. Any arbitrary combinations of these measuring points are possible, such that the first measuring point is constructed, for example, in the inlet of the anode area and the second measuring side is constructed in the outlet device of the cathode area. The pressure is preferably measured directly behind or in front of the cathode area and/or the anode area. In further embodiments, additional pneumatic elements may also be arranged between the measuring points and the anode and cathode area respectively.

In a further development of the device, another pressure sensor for measuring the pressure, particularly the absolute pressure is constructed or arranged in the anode area and/or in the cathode area. In conjunction with the differential pressure sensor, this additional sensor makes it easy to calculate the absolute pressure in the anode and cathode areas.

Preferably, a second actuator is provided for controlling or regulating the pressure and/or the flow-though in the cathode area or anode area, based in particular on the measured and/or determined absolute pressure. Control of the cathode pressure by way of an absolute pressure measurement, with the control of the anode pressure by measuring the differential pressure, or control of the anode pressure by way of an absolute pressure measurement, with control of the cathode pressure by measuring the differential pressure, is particularly preferred.

In an advantageous embodiment of the device, the first actuator is constructed or arranged for the control of the inflow of fuel from a storage tank. This construction again stresses the inventive idea of highly dynamic regulation and/or control of the differential pressure, because a comparatively high excess pressure is present in the storage tank in comparison to the anode circuit. Thus, a considerable pressure change in the anode area can take place by activating the first actuator.

The first and/or the second actuator is or are preferably constructed as a valve, particularly a proportional valve and/or an adjustable pressure reducer. Highly dynamic valves, such as piezo valves, are particularly advantageous.

According to a feature of the invention, the control device regulates or controls the first actuator based on a desired value for the differential pressure. In the case of simple embodiments, this desired value is constant; however, it is preferably adapted dynamically, particularly as a function of the time and/or of the load.

The object of the invention is also achieved by a method of controlling the differential pressure between an anode area and a cathode area of a fuel cell, in which the fuel cell is supplied with hydrogen from a refuellable storage tank, preferably by using the above-described device. The differential pressure between the anode area and the cathode area is measured by means of a differential pressure sensor, and the pressure in the anode area and/or the cathode area is adjusted on the basis of the measured differential pressure.

Other objects, advantages and novel features of the present invention will become apparent from the following detailed description of the invention when considered in conjunction with the accompanying drawings.

### BRIEF DESCRIPTION OF THE DRAWINGS

The single FIGURE is a schematic flow diagram of an embodiment of a gas supply system for a fuel cell according to the invention.

### DETAILED DESCRIPTION OF THE DRAWINGS

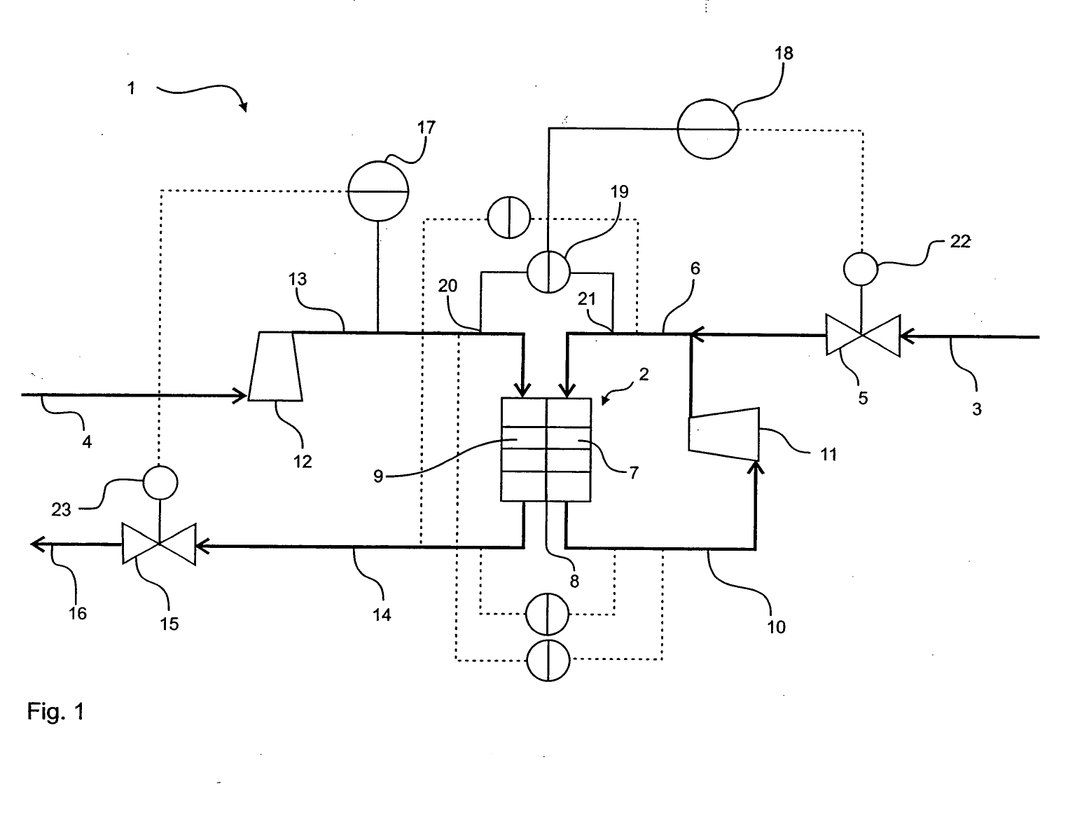

The gas supply system 1 schematically illustrated in FIG. 1 is used to supply a fuel cell 2. A feed pipe 3 supplies the gas supply system 1 with hydrogen from a gas tank (not shown), while another feeding pipe 4 feeds ambient air to the gas supply system 1 as an oxidant.

The hydrogen, which is used as a fuel, is guided from the feeding pipe 3 via an anode pressure valve 5, which adjusts the pressure in the anode branch of the gas supply system 1, into the inlet device 6 for the anode area 7 of the fuel cell 2. In a known manner, the hydrogen traverses the anode area 7 and is partially consumed there electro-chemically in that it is converted to hydrogen ions while releasing electrons, which hydrogen ions penetrate the separating PEM electrolyte wall 8 from the anode area 7, into a cathode area 9 of the fuel cell 2. The remaining hydrogen and possible additional carrier gases flow over from the anode area 7 into the outlet device 10, and are guided to a recirculation pump 11 which returns the unconsumed hydrogen into the inlet device 6 of the anode area 7.

The air used as the oxidant is guided by way of the feeding pipe 4 into a compressor 12, is compressed there as a function of the operating condition of the fuel cell 2 (particularly the applied load), and is fed into an inlet device 13 for the cathode area 9. The compressed air is guided through the cathode area 9, in which case, in an electro-chemical reaction, portions of the oxygen of the air together with the transferred hydrogen ions are converted to water. This air-water mixture is then guided by way of an outlet device 14 to a cathode pressure valve 15, which adjusts the pressure in the cathode branch of the gas supply system 1. Behind the cathode pressure valve 15, the air-water mixture is carried away by way of an outlet device 16.

The pressure in the cathode branch of the gas supply system 1 is regulated or controlled by means of a cathode pressure controller 17, which receives as the measured variable the absolute pressure in the inlet device 13 to the cathode area 9 and thus the absolute pressure of the cathode area as the input quantity. A desired value for the pressure of the cathode branch or area 9 is fed as the command variable to the cathode pressure controller 17, for example, as a function of the load. For controlling, regulating or tracking the pressure in the cathode branch, the cathode pressure controller 17 controls the cathode pressure valve 15.

An anode pressure controller 18 for the anode branch of the gas supply system 1 receives a measuring signal of a differential pressure sensor 19. A first measuring point 20 of the differential pressure sensor 19 is situated in the inlet device 13 to the cathode area 9; a second measuring point 21 is situated in the inlet device 6 to the anode area 7. The differential pressure sensor 19 thus measures the differential pressure between the cathode area 9 and the anode area 7, and the resulting measuring signal is compared in the anode pressure controller 18 with a desired value, (which may be either constant or a function of the time and/or the load). A controlling, regulating and/or tracking signal is formed which is fed as an adjusting signal to the anode pressure valve 5. Optionally, the absolute pressure in the anode branch and/or cathode branch is measured by absolute pressure sensors 22 and 23 respectively.

During the operation of the gas supply system 1, a load-dependent air quantity is guided by way of the feeding pipe 4 and the compressor 12 into the cathode area 9. The pressure of the fed air is adjusted by way of the cathode pressure valve 15 on the basis of the measured cathode pressure.

In the anode branch of the gas supply system 1, hydrogen is consumed in a closed circuit which is formed by the inlet device 6, the anode area 7, the outlet device 10 and the recirculation pump 11. Unreacted hydrogen is returned to the inlet device 6 by way of the recirculation pump 11. The pressure in the anode branch and thus in the anode area 7 is controlled by the anode pressure control valve 5, which feeds hydrogen from the storage tank (not shown) to replace the electro-chemically consumed hydrogen.

The control (particularly, the opening) of the anode pressure valve 5 takes place on the basis of the measured differential pressure between the anode area 7 and the cathode area 9, with the pressure control in the anode branch tracking the measured pressured difference with respect to a defined desired value. (The desired value can be selected arbitrarily, particularly as a function of the load.) Because of the direct measurement of the differential pressure, the gas supply system 1 permits a high precision for the differential pressure control.

Alternatively, the measuring points of the differential pressure sensor 19 may also be arranged at the outlet devices 10 and 14 respectively of the fuel cell 2 or at the inlet device 13 and the outlet device 10 of the fuel cell 2 or at the outlet device 14 and the inlet device 6.

In principle, any measured differential pressure between the anode area 7, or its inlet or outlet device 6 or 10, and the cathode area 9, or its inlet or outlet device 13 or 14, can be used as a measuring signal for the anode pressure controller 18.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A device for controlling differential pressure between an anode area and a cathode area of a fuel cell, wherein:
the device is connectable with a refuellable storage tank for hydrogen and has a first actuator for adjusting pressure in at least one of the anode area and the cathode area;
a differential pressure sensor is provided for measuring the differential pressure between the anode area and the cathode area; and
a control device controls the first actuator on the basis of a differential pressure signal of the differential pressure sensor.

2. The device according to claim 1, wherein the first actuator is configured to control an inflow of fuel into the anode area.

3. The device according to claim 1, wherein the differential pressure sensor comprises:
a first measuring point in one of the inlet device and the outlet device of the anode area; and
a second measuring point in one of the inlet device and the outlet device of the cathode area.

4. The device according to claim 1, wherein a pressure sensor is provided for measuring absolute pressure in one of the anode area and the cathode area.

5. The device according to claim 1, wherein a second actuator is provided for controlling or regulating at least one of pressure and flow through one of the cathode area and the anode area.

6. The device according to claim 1, wherein the first actuator is configured to control inflow of fuel from the storage tank.

7. The device according to claim 1, wherein at least one of the first and the second actuator comprises a valve.

8. The device according to claim 1, wherein the control device is configured to regulate or control on the basis of a desired value for the differential pressure.

9. The device according to claim 7, wherein at least one of the control device and an additional control device is configured to adapt the desired value for differential pressure.

10. A method of controlling differential pressure between an anode area and a cathode area of a fuel cell which is supplied with hydrogen from a refuellable storage tank, said method comprising:
measuring differential pressure between the anode area and the cathode area by means of a differential pressure sensor; and
adjusting pressure in at least one of the anode area and the cathode area based on measured differential pressure.

11. The method according to claim 10, wherein said measuring step comprises:
measuring said differential pressure between a first measuring point in one of the inlet device and the outlet device of the anode area; and
measuring said differential pressure at a second measuring point in one of the inlet device and the outlet device of the cathode area.

12. The method according to claim 10, wherein said adjusting step comprises controlling an inflow of fuel into the anode area.

13. The method according to claim 10, further comprising controlling at least one of pressure and flow through the cathode and anode area.

14. The method according to claim 10, wherein said adjusting step is performed based on a desired value for the differential pressure.
